(19) United States
(12) Patent Application Publication
(10) Pub. No.: US 2008/0052140 A1
(43) Pub. Date: Feb. 28, 2008

(54) DISTRIBUTED MEDIA PLANNING AND ADVERTISING CAMPAIGN MANAGEMENT

(75) Inventors: Greg Neal, Pleasanton, CA (US); Frank Williams, Erie, CO (US); Ron Hill, Broomfield, CO (US); Glynne Casteel, Westminster, CO (US); Hans Meyer, Denver, CO (US)

Correspondence Address: HENSLEY KIM & HOLZER, LLC, 1660 LINCOLN STREET, SUITE 3000, DENVER, CO, 80264, US

(73) Assignee: TRUEFFECT, INC., Broomfield, CO (US)

(21) Appl. No.: 11/844,991

(22) Filed: Aug. 24, 2007

Related U.S. Application Data
(60) Provisional application No. 60/839,779, filed on Aug. 24, 2006.

(51) Int. Cl. G06Q 10/00; G06Q 30/00

(52) U.S. Cl. 705/7; 705/1; 705/14

(57) ABSTRACT

A user can audition creatives with in a snapshot of a proposed web page of a publisher website in the local application. Multiple snapshots of proposed pages for placement may be downloaded from publisher web sites and stored in a local library. The user can replace existing advertisements or other creatives and the corresponding HTML code with proposed creatives to determine which creatives will provide the best contextual fit for the proposed web site and page. The graphical nature of the application enables the user to drag and drop a creative from a local palette selected from a creatives library onto a web page snapshot.

### CROSS-REFERENCE TO RELATED APPLICATIONS

This application claims the benefit of U.S. Provisional Application No. 60/839,779, filed Aug. 24, 2006, entitled “Distributed Media Planning and Advertising Campaign Management,” which is incorporated herein by reference for all purposes.

### TECHNICAL FIELD

Embodiments of the present invention relate generally to generating web pages. More specifically, embodiments relate to determining whether a selected creative is compatible with a destination location on a web page.

### BACKGROUND

Advertising via the Internet continues to grow and evolve at a rapid pace. However, there are a number of key players and relationships that form the basis of the Internet advertising industry. These key players include “publishers” who own one or more websites and provide advertising space thereon; “advertisers” who own one or more products or services that they wish to advertise via the websites; “agencies” who work with advertisers to develop advertising campaigns and advertising media, graphics, words, phrases, etc. (collectively, “creatives”); and third-party ad servers (TPAS) that serve ads on behalf of the advertisers and agencies.

When an advertiser wishes to begin a new advertising campaign, the advertiser often contacts an agency and together they design the creatives for the new campaign. The agency will often work with publishers directly to determine the websites on which the campaign will be displayed. The agencies will then send the ads to the TPAS so they can, in turn, load them into their systems and send redirect tags to the publishers. Publisher sites that sell advertising space each have their own requirements for ad types, number of animation loops length of animation, banner file size, banner dimensions, click-through behavior (e.g., launch in new window, launch in same window). Additionally, web publishers have specific locations for ads with associated demographic profiles of the users that visit those locations. For example, associated demographics may include gender, age, income, home ownership, education level, and children, as well as many others.

### SUMMARY

In many cases, creatives developed for a campaign are developed in a generic manner and the same creatives are displayed across all websites purchased for the campaign. Advertisers and their assigned agencies develop advertising creatives to communicate their message. It is beneficial to have the message, graphics, and colors of the creative be contextually relevant when they are viewed by the audience. Viewing a creative within its proposed context can help develop a better creative which in turn can help produce better advertising results.

In one implementation of a system described herein, the user can audition creatives within a snapshot of a proposed web page of a publisher website in the local application. Multiple snapshots of proposed pages for placement may be downloaded from publisher web sites and stored in a local library. The user can replace existing advertisements or other creatives and the corresponding HTML code with proposed creatives to determine which creatives will provide the best contextual fit for the proposed web site and page. The graphical nature of the application enables the user to drag and drop a creative from a local palette selected from a creatives library onto a web page snapshot.

Verification between the creative attributes and the web publisher placement specifications, e.g., creative dimensions, content restrictions, or other, is accomplished. If the advertising creative attributes are within the web publisher advertising specifications, the creative is visually attached to the web publisher placement. Based on how the initial creatives look on a specific publisher web page, creatives designers, with guidance from the advertiser, can view the proposed publisher advertisement space and can develop conceptual designs for each unique space. They can change the messaging, colors, or graphics on the general campaign parameters to provide a better communication vehicle for that particular advertising space. The system can further be used to test pending creatives within the context of the publisher advertisement space, e.g., by presenting numbers of animation loops, animation loop time, click-through window behavior (e.g., open in existing window, open in new window), and click-through to the correct destination.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 illustrates a suitable operating environment in which embodiments of the present invention may be implemented.

FIGS. 2-7 are screenshots of user interfaces that may be used in a campaign and creative management system in accordance with one embodiment.

FIGS. 8-10 are flowcharts illustrating algorithms for managing creatives in accordance with one embodiment.

FIG. 11 illustrates a general purpose computing system in which an embodiment may execute.

### DESCRIPTION

The methods described herein facilitate the workflows of the individual players as well as the workflows between and among the advertiser and/or agency, TPAS, and the publishers. A campaign and creative management (“CCM”) system includes a distributed media planning subsystem, a media buying subsystem, a campaign management subsystem, and a contextual creatives viewer subsystem. The CCM system supports a number of front-end interfaces including a spreadsheet, such as Microsoft Excel, web clients, and a graphical campaign manager. The CCM system utilizes networking technologies, e.g., web services, to communicate between a data repository, such as a database, and various front-end data entry applications. Alternatively, the CCM system can utilize one or more data repositories, one or more mid-level applications, and one or more front-ends and/or web clients.

Within the media planning subsystem, a number of modules may be used to facilitate workflows, for example, a media goals module; a request for proposal (“RFP”) module; a completed proposal module; a publisher and site selection module; an insertion order module; a creative insertion module, which includes creative grouping, targeting, and contextual creative viewing; a scheduling module; a closed loop/site measurement module; and a reporting module, which may include, for example, single campaign reporting, cross campaign reporting, and site measurement reporting for return on investment (ROI) analysis.

The media goals module allows the advertiser or agency to specify demographic targets of the campaign and plan the campaign strategy. Demographics may include, but are not limited to, age, income, gender, home ownership, children in home, educational level, and others.

The RFP module allows a user to select publishers and their respective sites to distribute RFPs, e.g., by e-mail or other means. RFPs may provide links to web pages that enable the publisher to enter RFP response data, which is stored in a data repository and refreshed to the various front-end applications (such as an Excel-based spreadsheet application). The completed proposal module displays the refreshed RFP responses from the publishers and sites.

The publisher and site selection module allows a user to review the publishers that have responded to the RFPs and select publishers and websites for the campaign. The insertion order module is configured for sending insertion orders with associated contracts to purchase the media. The reporting module facilitates the creation of reports that describe and explain the workflows and outputs within and from the CCM system as well as results from the active advertising campaign.

The creative insertion module may include the ability to drag and drop creatives in various creative formats (GIF, JPG, SWF, WMF, Flash, QuickTime, etc.) into the system, which can then be augmented with click-through destinations (single and multiple for rich media), and purpose information to aid in report analytics. The creative insertion module enables the user to view the creative “within the context” of the sites where it is proposed to play thus enabling the user to determine if the creative has the appropriate messaging, coloring, rotation, and other aspects for the planned site. The creative insertion module will also facilitate creative group implementation to enable the user to set up targeting and rotation parameters, for example, geographic targeting, first-party cookie targeting, and storyboarding.

The scheduling module enables the user to drag and drop creatives and creative groups onto placement locations to link the creatives with the placement locations in the system. This function may perform extensive error checking to ensure that creatives can be linked within appropriate placement locations. For example, a 728×90 pixel banner may not be placed in a 160×600 pixel purchased space. The scheduling module can also facilitate the “trafficking” function which generates trafficking “tags” to be forwarded to the publishers and sites as well as “pushing” the creatives to the server farms in anticipation of requests from the browsers.

The reporting module can extract reporting information from the data warehouse based on a single campaign or multiple campaigns. It may enable the user to report on impressions and click-through information along with extensive advertiser site visit information to facilitate return on investment (ROI) reporting. The report module may facilitate quick data transition into a pivot table format (e.g., in Microsoft Excel) for data formatting and analysis.

An exemplary implementation may be understood in the context of a user working at an advertising agency. The front-end interface of the system facilitates the work-flow, which may be presented within the context of a familiar spreadsheet application. For this example, the user launches the CCM system front-end interface software, logs in, and begins to work with the media goals module. The user launches a new campaign, names the campaign, and sets the flight dates (i.e., the start and end dates for the campaign), for example, using a modified actions pane within the spreadsheet. Next, the user selects the target demographics for the campaign (such as age, gender, etc.). A notes field is available to the user in case she wishes to communicate a special question or request to the publisher web sites who will be receiving the request for proposals concerning this new campaign.

Once the user has completed the media goals workflow described above, she moves to the RFP module, which allows her to choose publishers, websites, and site sections, as well as to modify other customizable fields/columns. The listings of available publishers, websites, etc., can be sorted and ranked by relevance based on the target demographics previously selected. A data repository, such as a database, can contain all the data that feeds the drop-down menus and available selections described above. The CCM may communicate through web services to a hosted or locally operated database to store and retrieve all of the application data. A third party can update the database or the agency can keep it updated. Alternatively, the third party can perform selective updating, thereby updating only data that has not been updated by the agency.

The CCM system may include a web publisher directory which can be unique by advertiser or agency or can be shared across advertisers and agencies. Depending upon how the directory owner (advertiser or agency) sets the permissions, various people may update the web publisher information in the directory. For example, the directory owner may set the permission to allow web publishers to update their own information. Alternatively, the directory owner may restrict change access and limit edits to the owner, thus enhancing the security of the directory and its data. The web publisher directory is a library of publishers with their associated demographics and advertising specifications along with advertisements that the advertiser would like to use to communicate their message.

Once the RFP selections have been made, the CCM system may contact publishers via e-mail or some other communication method. The CCM system can utilize third-party software, such as Outlook, to send e-mails. Publisher contact information can be kept up-to-date using Outlook's v-card features, web-forms, etc. The RFP messages may include a link to a web interface through which the publishers may enter response information to the RFP. When the publishers receive the e-mails, they can select the enclosed links and navigate to a third-party website or an agency website that is designed as part of the overall system. The publishers may login to the website and respond to the RFP using a web-form. Alternatively, the publisher can reply to the e-mail to provide the necessary information. The RFP can have a window of opportunity during which time a publisher can respond. The CCM system can be configured not to accept responses outside of the window.

After the publishers have responded to the RFP's, the user can update the front-end interface software or the software may automatically update based on the changes. The user may employ the proposal module to review the responses and accept those responses that best meet the requirements, e.g., best pricing, most traffic, best demographic fit, etc. At this point, the user can generate a report using the generate view function to inform the advertiser status of the project's and ask for sign-off to begin advertising.

Once permission has been granted, the user employs the insertion order plan module, which is populated with the information from the accepted responses. At this point the user can choose to use the insertion order module to send insertion orders, which may include contracts such as purchase and delivery agreements. Once the insertion orders are completed the user may accept the insertion orders. The user can then move on to the creative import module to import the creatives for the campaign.

Creative import may be facilitated by drag and drop functionality or manual file selection and import. Once imported, a creative details screen may be used to enable the user to add details to the creative such as single or multiple click through destination URL's and creative purpose designations. Additionally, the user can use a creative group module to group similarly themed creatives for targeting, for example, geographic and cookie targeting, as well as story-boarding. The user can also leverage the contextual creatives viewer function to view the uploaded creatives within the context of a proposed site. For instance, the user may right-click on a creative and select a site from those listed in the insertion order module. The site will then display placing the creative in the appropriately sized ad space on the site. Users will be able to view the creative within its context to verify the messaging, colors, and rotation settings.

The CCM system may also include a creative library in which the advertiser or agency may add creatives (i.e., advertisements and other content) that are intended to be used for advertising campaigns. When creatives are uploaded or imported into the library, their creative attributes are checked and entered into the database.

Once the user has uploaded and set up the creatives and creative groups they can move to the schedule module to link the correct creatives to their associated placement on the sites. They can navigate a hierarchy of creative groups and creatives to select a specific creative and place it on a specific placement location. Alternatively, the user can drag and drop the entire creative hierarchy onto the entire placement hierarchy and let the system create all of the links. The system is intelligent enough to check many factors to determine a valid match between the creative and placement including but not limited to creative and placement dimensions and creative and placement file types.

Once the creatives are scheduled on the placements the user can choose to “push” the campaign which creates and sends “tags” to the publishers and sends the creatives to the ad server farms in anticipation of requests from browsers. The user can then use the reporting module to extract reporting information from the data warehouse based on a single campaign or multiple campaigns. It may enable the user to report on impression and click information along with extensive advertiser site visit information to facilitate return on investment (ROI) reporting. The report module may facilitate quick data transition into a Microsoft Excel pivot table format for data formatting and analysis.

In one implementation the user can build the campaign through a graphical user interface. The graphical campaign manager consists of at least the following: 1) a graphical interface consisting of a pallet of objects representing publisher and advertiser web pages; 2) a canvas for creating the campaigns; 3) a database to store all of the campaign data; and 4) a contextual creatives viewer.

In this scenario the user will drag and drop icons representing publishers and sites onto the canvas. The user will either double-click or right-click on the icons and select from choices provided by the database to designate that icon as a specific publisher or site. The user will drag and drop subsequent icons and either link them to previous publishers and sites or create them as an additional publisher and site. Linking them to a previous publisher or site will then initiate a hierarchy of publisher/site/site section/placement/creative.

Initially, the user will create the publisher/site hierarchy and then select (e.g., double-click or right-click with a mouse interface) on the icons to send RFPs. Icons may visually change using color or font or line thickness to designate the status of the RFP (e.g., sent, received, responded, accepted, or rejected). Once sites are accepted, insertion orders can be sent and then creatives can be dragged and dropped onto the placements. Once the campaign is running, the interface may utilize visual cues to inform the user as to the status of the campaign. For example, green may mean that there is nothing wrong and red may highlight a problem. The user will also be able to select any level in the hierarchy to receive context sensitive information. For example, the user can select a site and view a dashboard containing information about all site activity relevant to the campaign. Selecting a specific creative provides the user a choice of viewing reports for that creative across the campaign or for that specific placement.

If the user needs to make any campaign changes or look at performance reports they will be able to double-click or right-click on any icon and utilize the dashboard that comes up for that level. The dashboard will either provide direct access to fields or links to subsequent dashboards which enable the user to take actions such as adjusting creative group targets or retiring one creative and adding another.

A mapping subsystem may be utilized wherein any agency-specific templates that a particular agency wishes to use are mapped to the front-end interfaces to allow the use of proprietary and custom templates within the CCM system. One feature of the mapping subsystem converts links to proprietary databases in any existing templates so that they function with the CCM system's data repository. In some embodiments, the CCM system may adapt to agency templates.

In one implementation of the CCM system, a spreadsheet application (e.g., Microsoft Excel) may be used to support a front-end application. A movable actions pane within the spreadsheet may be configured to enable the user to select standard options which are populated from the data repository and which, in turn, populate fields in the spreadsheet interface. The media goals module can be implemented as a worksheet having drop-down fields in the actions pane that are populated with selections based on the user's login name and password. The selections may be associated with a specific agency or advertiser. Agencies often work for more than one advertiser, so each agency would therefore have one or more advertiser selections in the advertiser drop-down field.

The login name and password security can have additional features. For example, when a user first logs in to a default spreadsheet front-end, an agency ID can be associated with that spreadsheet and the spreadsheet cannot be opened for editing by anyone without an authorized login for that agency. If a user does not have the proper login, the spreadsheet can be opened in read-only mode for review by management and the advertiser, for example.

An additional feature of a spreadsheet-based front-end is the ease at which worksheets can be populated with data that is entered, selected, or rejected on another worksheet. For example, when a user sets an RFP status to “accept,” the data in that row is automatically passed on and populates the insertion order worksheet. Additionally, the look and feel of the interface can be updated automatically in response to data that is entered, selected or rejected on a worksheet. Using the RFP status change example again, the background color of RFP status rows that have been set to “accept” can be automatically changed to green, “reject” rows can be automatically changed to red, and “tentative” rows can be changed to yellow.

In the reporting module, automatic pivot tables and pivot charts can be used. The data from the RFP, insertion order, and campaign report worksheets can be viewed in many different ways to enable the user to determine the best media mix across an advertising campaign. Other reporting functionalities can include pie-charts, graphs, and other data analysis charts.

The CCM system may support multiple front-end user interfaces. For example, if a publisher user logs in to a web interface and responds to an RFP, a corresponding spreadsheet interface (e.g., Excel) can be configured to update itself with the new publisher RFP response information. Further, the spreadsheet can automatically update with information when a publisher user selects a proposal submission function in the web interface. The proposal submission selection signifies that the publisher at least viewed the RFP and either responded or chose not to enter data. Another automatic update of the data in the front-end can occur whenever a user changes worksheets. These automatic update features help to ensure that the user is working with the most recent data.

Another feature in a front-end interface is the ability to track workflow and other changes that a user makes. A user following a course of work can progress from the media goals module to RFPs, through new RFPs to sent RFPs, through received RFPs to responded RFPs, or through accepted or rejected RFPs to insertion orders.

In one implementation, a publisher user can log in to the CCM system and add “special deals” or other proprietary information to the publisher notes section. This information is then displayed to an advertiser or agency user when the user selects web sites for a campaign. Additionally, an advertiser or agency can place notes in its own notes section. In another implementation, the CCM system works in concert with Really Simple Syndication (RSS) feeds so that publishers can “publish” proprietary information such as special deals. The CCM system can automatically read the RSS feeds and display the data in the site selection process. Another feature of the site selection process is the ability for a user to select demographic targets for a campaign. The CCM system then displays resulting websites based on the relevance of those websites to the selected targets. A user can select any or all of the resulting sites manually or through the use of an option to select all relevant sites. Selected sites are automatically copied into the RFP worksheet module.

The CCM system links to other software, including third-party software, to provide an integrated solution to the user. For example, the CCM system can send RFP and insertion order e-mail through the user's e-mail software/system. E-mail systems can be configured so as to save all such e-mails for auditing purposes. Additionally, the CCM system can utilize an XML interface to link to other systems. This feature enables the CCM system to exchange data with many other types of systems including other ad serving systems, financial systems, publisher/site database systems, and reporting/business intelligence systems.

The CCM system is highly customizable in order to meet the needs of advertisers, agencies, and publishers. For example, the CCM system can be a stand-alone system within the advertiser/agency or it can be hosted by a third party. The CCM system can be configured so it appears to be owned and operated by an agency or advertiser through a “private label” process. Further customizable settings include, but are not limited to, RFP expiration dates, login security options, and number of times logged in by user or user groups. These settings can be configured individually or by an automated process based on the privacy and security policies within a particular agency or advertiser. The CCM system provides further security enhancements via a tracking feature which tracks each login to an RFP to see which users logged in and at what times. By storing such tracking data, an audit trail is provided that demonstrates the validity of an RFP.

Publisher sites that sell advertising space each have their own branded colors, font type, and graphics. When a user navigates using an Internet browser to a web page, the HTML coded representation of that web page is downloaded to the user's browser. The HTML code is then interpreted, pulling content from many locations as directed by the HTML code, to build the page representation on the user's computer. At this point in time, the HTML coded web page is resident on the user's computer.

One implementation of a web publisher directory application is a library of publishers with their associated demographics and advertising specifications along with advertisements that the advertiser would like to use to communicate its message. The application allows the user to simply drag and drop publishers onto a “canvas” and subsequently drag and drop advertisements onto the selected pages for those web publishers. Error checking built into the application will highlight problems with dropping an out-of-specification advertisement onto a web publisher advertising placement. For example, the user selects a CNN web page snapshot for presentation on the canvas. The CNN web page snapshot has allowable placement locations of 728×90 pixels and 160×600 pixels. If the user tries to drag and drop a 300×250 pixel advertisement onto the selected web page snapshot, the application can highlight that the allowed advertising sizes and the recently dropped advertising size do not overlap and will highlight that as a discrepancy. The user will then have the option of adding a new advertisement size to that particular web publisher placement or to cancel and select another advertisement with different dimensions. The user can multi-click on any of the placed sites and site sections to reveal their respective attributes.

In many cases, creatives developed for a campaign are developed in a generic manner and the same creatives are displayed across all websites purchased for the campaign. Advertisers and their assigned agencies develop advertising creatives to communicate their message. It is beneficial to have the message, graphics and colors of the creative be contextually relevant when they are viewed by the audience. Viewing a creative within its proposed context can help develop a better creative which in turn can help produce better advertising results.

In the graphical campaign manager, the user can multi-click or right-click on any object and select reports to generate context sensitive reports at that object level. For instance, once report data is available, the user can multi-click on a banner object on the canvas and select report and get a report for that specific advertisement within that specific placement. If the user multi-clicks on a specific website and selects report, they will get a report for all of the advertisements running from this campaign on that specific web site.

### Exemplary Operations

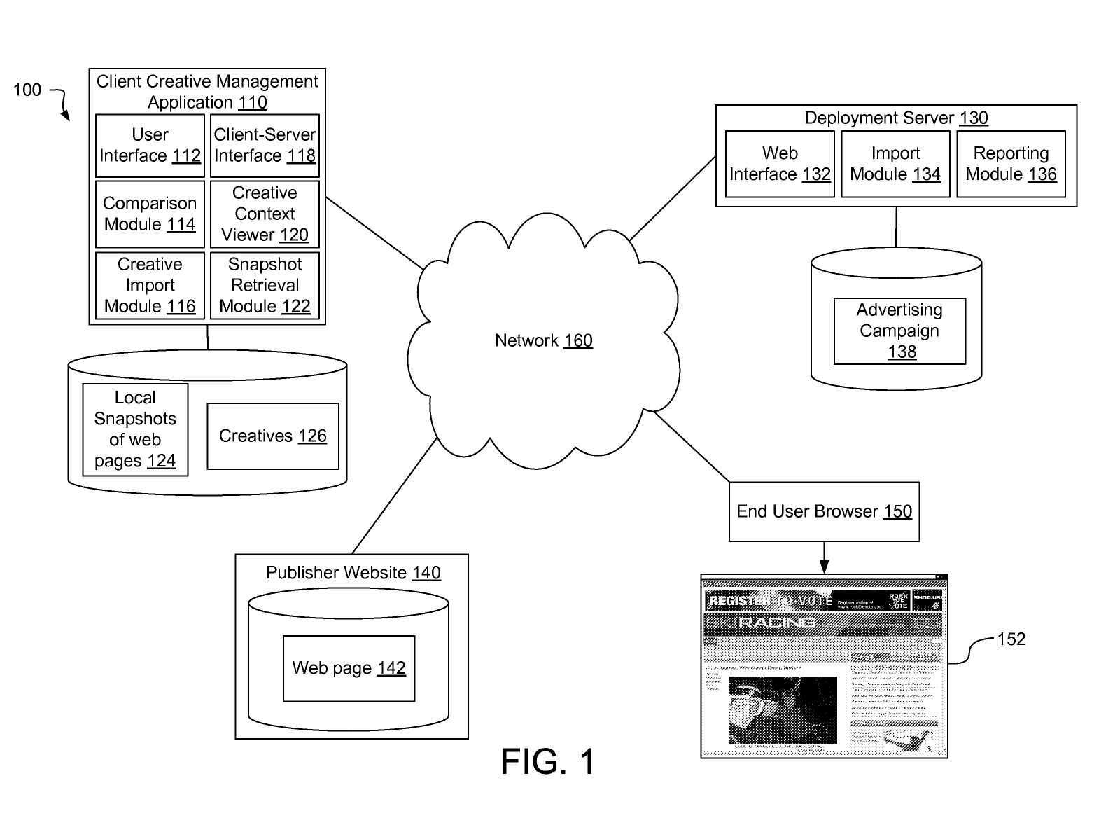

FIG. 1 depicts a suitable operating environment in which embodiments of the present invention may be implemented. A client creative management application 110, a deployment server 130, a publisher web site 140, and an end user browser 150 are connected via a network 160. The client creative management application 110 provides an environment for developing and testing an advertising campaign utilizing creatives. Once an advertising campaign is developed, it may be deployed via the deployment server 130 to be displayed as part of one or more web pages 142 on the publisher website 140. The web pages 142 on the publisher website 140 may then by viewed by an end user browser 150, as shown in exemplary browser screen shot 152.

The client creative management application 110 may include a user interface 112, a comparison module 114, a creative import module 116, a client-server interface 118, a creative context viewer 120, and a snapshot retrieval module 122. The user interface 112 may be a front-end interface of the application that facilitates workflow, such as a spread sheet or other graphical user interface. The user interface 112 may allow a user to identify one or more creatives, which may be stored locally or remotely, to be used in a new advertising campaign. The identified creatives are added to the advertising campaign using the creative import module 116 and stored as creatives 126. The user interface 112 may also allow a user to identify one or more websites or web pages on which the advertising campaign is to be displayed. Once one or more websites are identified, the snapshot retrieval module 122 retrieves a snapshot of the identified websites or web pages and stores the snapshots as local snapshots of web pages 124. The local snapshots of web pages 124 include includes all of the HTML and other underlying coding of the original web page in order to provide an audition space for the creative in the same environment in which it would ultimately be presented.

The comparison module 114 then compares attributes of the imported creatives 126 and local snapshots of web pages 124 to determine whether the creatives identified for use in the advertising campaign are compatible with the web pages on which the creatives are to be displayed. For example, the comparison module 114 may compare the dimensions of a creative with the dimensions of an available advertising space on a locally stored snapshot of a web page to determine whether the creatives are compatible with the available advertising space on the desired website. Other attributes, for example, content, demographics, or other data, relating to the creative and the desired advertising space may also be used for comparison to determine compatibility.

The creative context viewer 120 allows one or more imported creatives 126 to be displayed in the desired advertising context using local snapshots of web pages 124. For example, a local snapshot of a web page may be selected by a user, and then the user may select for display in the web page one or more of the imported creatives 126. Thus, compatibility of a creative with the desired web page or advertising location can be verified. Further, by inserting the creative into the appropriate advertising space in the web page and providing for full functionality of the web page and any links while the creative is displayed, the web page can be viewed and accessed as it would be viewed and accessed over the Internet by the target audience. Thus, the advertising campaign can be evaluated as it is created, and prior to deployment.

After an advertising campaign is created, the client-server interface 118 is used to communicate with the deployment server 130 over the network 160 for deployment of the advertising campaign. Using an import module 134, the deployment server may acquire the completed advertising campaign from the client creative management application 110 via the network 160. The acquired advertising campaign 148 may be stored at the deployment server 130. The deployment server 130 may be provided with a web interface 132 to allow for programming attributes of the advertising campaign such as timing, frequency, and association with one or more publisher websites. Additionally, the deployment server 130 may include a reporting module 136 to report statistics relating to the deployed advertising campaign.

When an end user accesses a web page 142 on the publisher website 140 on which a creative in the advertising campaign is to be displayed, the deployment server 130 will serve the appropriate creative so that it is displayed as a part of the web page 142 on the publisher website 140 when viewed at the end user browser 150, as shown in browser screen shot 152. Thus, the advertising campaign created using the client creative management application 110 is integrated into the publisher website 140.

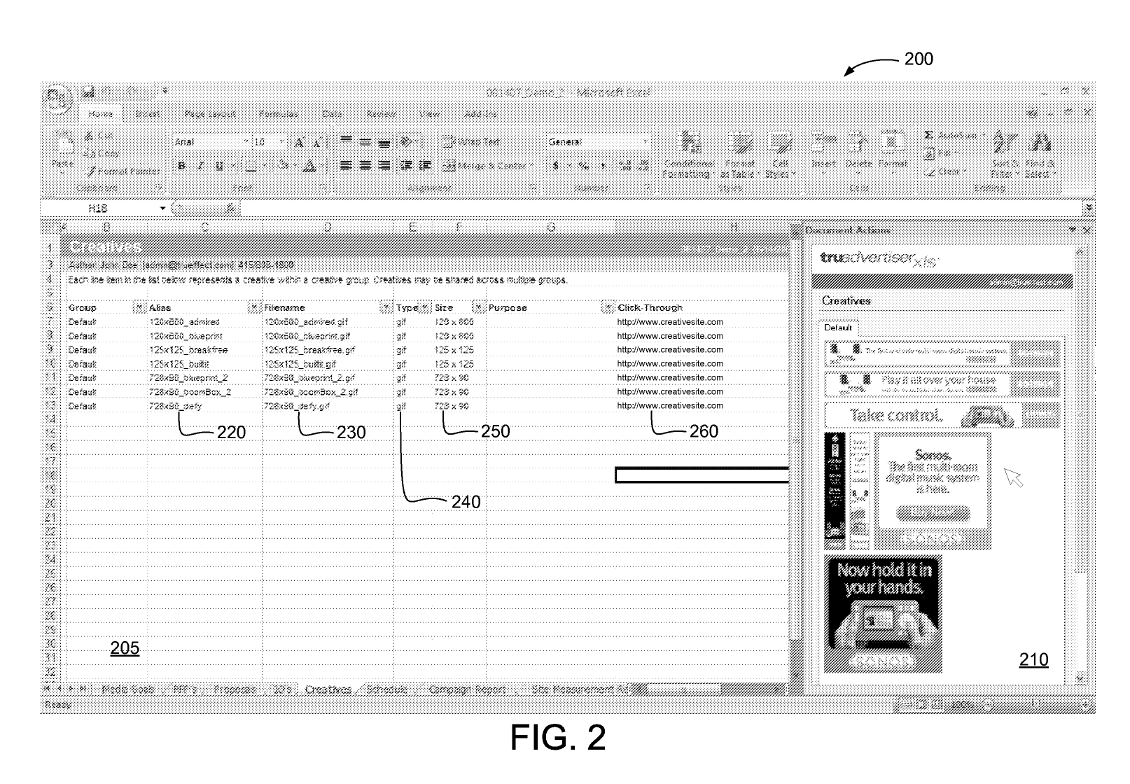

FIG. 2 depicts an exemplary screen shot of a user interface 200 of the CCM system in which a listing of the attributes of a plurality of creatives is displayed in a first pane 205 and the files corresponding to each creative are displayed in a second pane 210. Each of the listed attributes is editable. For each creative, an alias 220 is displayed. The alias for each creative may, for example, correspond to the filename of the filename. The alias may also be added or edited in pane 205. The filename 230 and file type 240 are also listed for each creative. GIF, JPG, SWF, WMF, Flash, QuickTime, etc. are types of files that may be used as creatives. The size or dimensions 250 of each creative is also listed and may be edited. These dimensions may be used to determine whether or not a creative is compatible with an available advertising space. A click-through 260 is also listed for each creative, and may be edited in pane 205. The creative will serve as a link to the site listed as the “click-through” so that, if a user clicks on a creative, the user's browser will be directed to the click-through site. In an implementation, the creatives displayed in pane 210 may be operational. Additionally, other attributes relating to the creatives, such as content tags, may be displayed in pane 205.

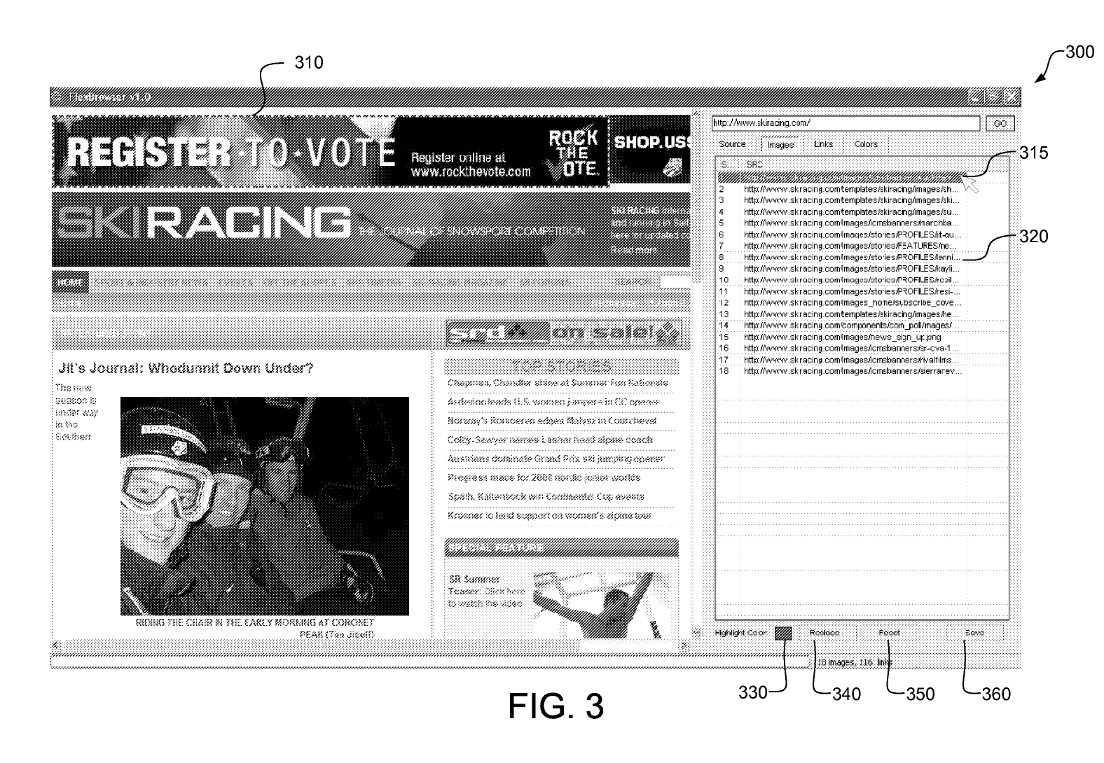

FIG. 3 depicts an exemplary screen shot of a user interface 300 showing a local snapshot of a web page. Pane 320, shown at right, lists the source or location of each image displayed as a part of the web page. File 315, which is highlighted in pane 320, corresponds to location 310 in the local snapshot of the web page. As shown in FIG. 3, when an image is highlighted in pane 320, the corresponding location in the snapshot of the web page is highlighted, as well. In another implementation, if an image displayed in the local snapshot were selected or highlighted by a user, the corresponding entry in pane 320 would be highlighted, as well.

The highlight color may be changed, for example, using drop down box 330. By selecting a replace button 340, a user may be permitted to replace an existing image displayed in the snapshot with a different image. A reset button 350 may be used to restore the snapshot of the webpage to its original, unaltered state or newest webpage available. An altered web page snap shot may be saved locally using a save button 360.

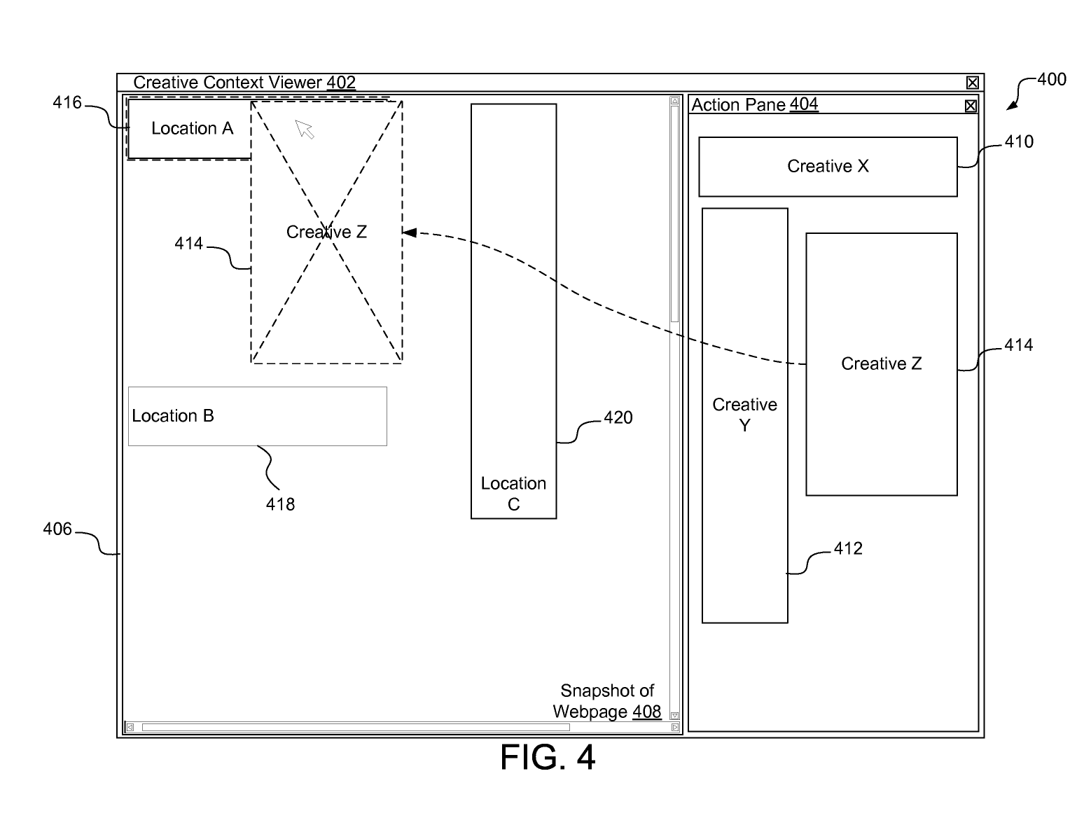

FIG. 4 depicts an exemplary screen shot of a user interface 400 of the CCM system in the creative context viewer 402 mode. The creative context viewer 402 may be presented in two panes as shown in FIG. 4, an action pane 404, and a canvas 406. A snapshot 408 of a web page is presented within the canvas 406. As discussed above, the snapshot 408 is a capture of a proposed web page for placement of a creative. The snapshot 408 includes all of the HTML and other underlying coding of the original web page in order to provide an audition space for the creative in the same environment in which it would ultimately be presented.

The creative contextual viewer 402 provides an environment for easily determining whether particular creatives are appropriate for placement on a proposed web page before a media buy is made. Several creatives, Creative X 410, Creative Y 412, and Creative Z 414 have been loaded into the action pane 404, for example, from a creative library as previously described. Each of the creatives 410, 412, 414 may have different attributes, for example, dimensions, messaging, colors, animation, sound, click-through links, demographic targets, etc. The snapshot 408 is presented within the canvas 406 window of the creative contextual viewer 402 and possible creative placement locations, Location A 416, Location B 418, and location C 420 are depicted. Each of the placement locations 416, 418, 420 may be receptive to creatives with certain attributes but not with others.

When a placement location is selected, for example, Location A 414 as depicted in FIG. 4, the location may be highlighted to indicate such selection, e.g., by outlining the creative location with a colored line (as indicated by the dashed line in FIG. 4) or by other methods. Additional information about a selected placement location 414 in the snapshot 408 may be presented to a user. For example, an additional or alternate action pane may be activated to provide attribute information acceptable to the placement location or web page, e.g., dimensions, file type, content restrictions, etc. Alternately, attribute information may be provided through a pop-up window on mouse roll-over or in response to a “right-click” operation.

A user may attempt to determine whether a creative is compatible with a placement location on the publisher's web site by dragging one or more creatives from the action pane 404 and dropping it onto a creative location within the snapshot 408 on the canvas 406. As depicted in FIG. 4, Creative Z 414 has been dragged by the user and dropped on top of Location A 416 as indicated by the temporary image of Creative Z 414′. If the attributes of Creative Z 414 are acceptable for placement in Location A 416, the CCM system will replace the original creative material in Location A 416 captured in the snapshot 408 from the publisher's web site with the selected Creative Z 414 from the action pane 404.

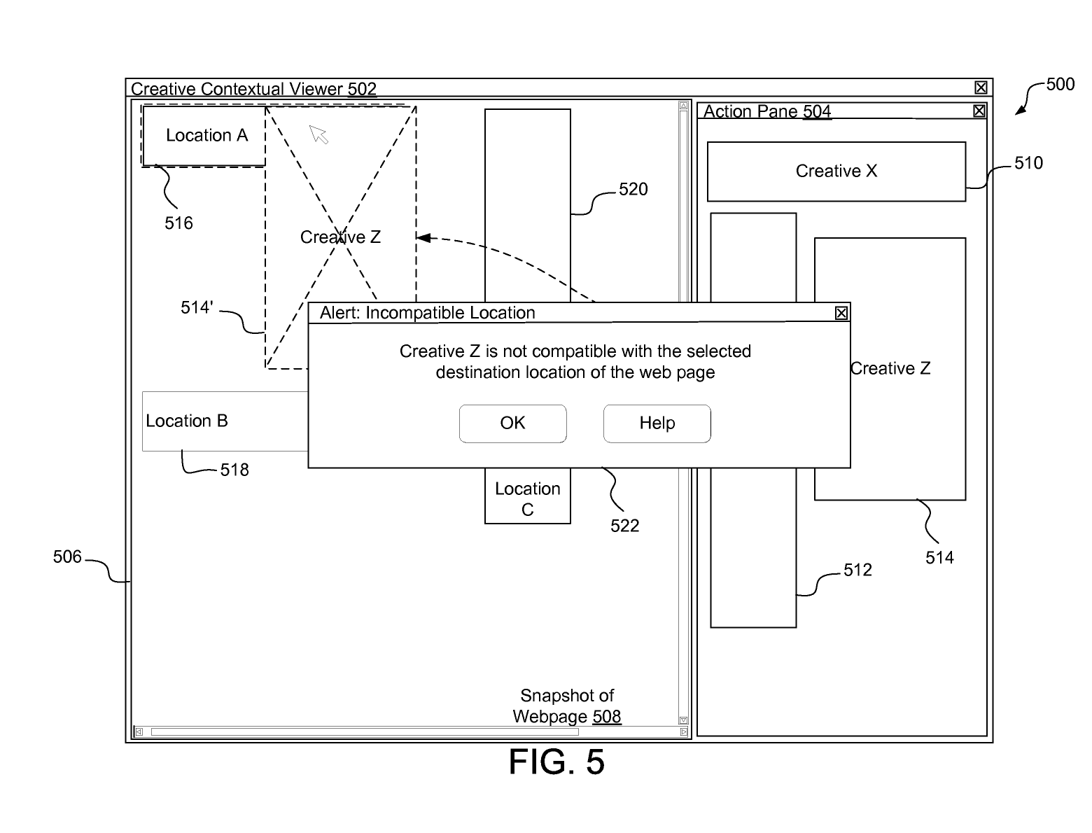

As shown in the user interface 500 of FIG. 5, however, the attributes of Creative Z 514 are not compatible with Location A 516 of the web page snapshot 508. For example, the dimensions of Creative Z 514 may not conform to the acceptable dimensions for placement Location A 516. This is graphically depicted in FIG. 5 as the temporary image of Creative Z 514′ does not visually coincide with the dimensions of Location A 516. Creative Z 514 is thus rejected for placement in Location A 516 and an alert 522, for example, in the form of a pop-up window, may be presented to the user to indicate the incompatibility of the creative with the placement location. While the example of FIG. 5 is somewhat exaggerated for visual effect, for creatives of similar shape and orientation, but different dimension (e.g., ad sizes of 300×250 pixels and 180×150 pixels), this filtering ability is beneficial. Further, the CCM system also compares or filters other, non-visual attributes and notifies a user of any incompatibility which may not otherwise be apparent.

In a further implementation (not shown), all of the creatives 510, 512, 514 in the action pane 504 may be selected, dragged, and dropped onto the snapshot 508 in the canvas 506 and the creative contextual viewer 502 may automatically determine which of the creatives 510, 512, 514 is compatible with each of the placement locations 516, 518, 520. The CCM system may display such a determination as a listing in an alternate view or pane (e.g., accessible via a tab configuration) within the action pane 502. In one exemplary implementation, each location 516, 518, 520 may be listed in the action pane 502 and under each location any compatible creative may be respectively listed. Any creatives determined to be incompatible with all locations could also be listed under a separated incompatibility heading within the action pane 502.

The contextual creatives viewer subsystem of the CCM system allows the user to navigate to the proposed publisher website. When the HTML code is downloaded from the publisher website to the local application, the user can replace existing advertisements with proposed advertisements to determine which advertisements will provide the best contextual fit for the proposed website and page.

In one implementation, the contextual creatives viewer module can be used in the campaign planning process within a campaign media planning and purchasing system to plan the purchases of creatives within the context of placements (e.g., top of page, right center of page, right hand side of page, etc.) and the creatives′ sizes (e.g., 728×90 pixels, 300×250 pixels, 160×600 pixels, and 180×150 pixels).

In another implementation, the contextual creatives viewer subsystem can also be used in the campaign setup process within the context of a graphical campaign management application to place the finished creatives into their assigned spaces. The graphical campaign management application will then schedule the creatives to be placed within those positions when the publisher enters the redirect tags into their site serving system.

The contextual creatives viewer contains a creatives library in which the creatives library owner (advertiser or agency) will add creative advertisements that are intended to be used for advertising campaigns. When advertising creatives are uploaded into the library, their attributes are checked and entered into the database. The graphical nature of the application enables the user to drag and drop a creative from the palette onto a web publisher page which is on the canvas. Verification between the advertising creative attributes and the web publisher placement specifications is accomplished. If the advertising creative attributes are within the web publisher advertising specifications, the creative is visually attached to the web publisher placement. The user can multi-click on any of the placed creatives to reveal their respective attributes.

In yet another implementation, the contextual creatives viewer subsystem can be used to test pending creatives within the context of the publisher advertisement space and view their number of animation loops, animation loop time, creative dimensions within the space allowed, messaging, colors, graphics, click-through window behavior (e.g., open in existing window, open in new window), and click-through to the correct destination. The contextual creatives viewer module can also be used to “sell” the advertiser on the conceptual creative design, messaging and graphics as well as the proposed publishers and their associated advertisement space.

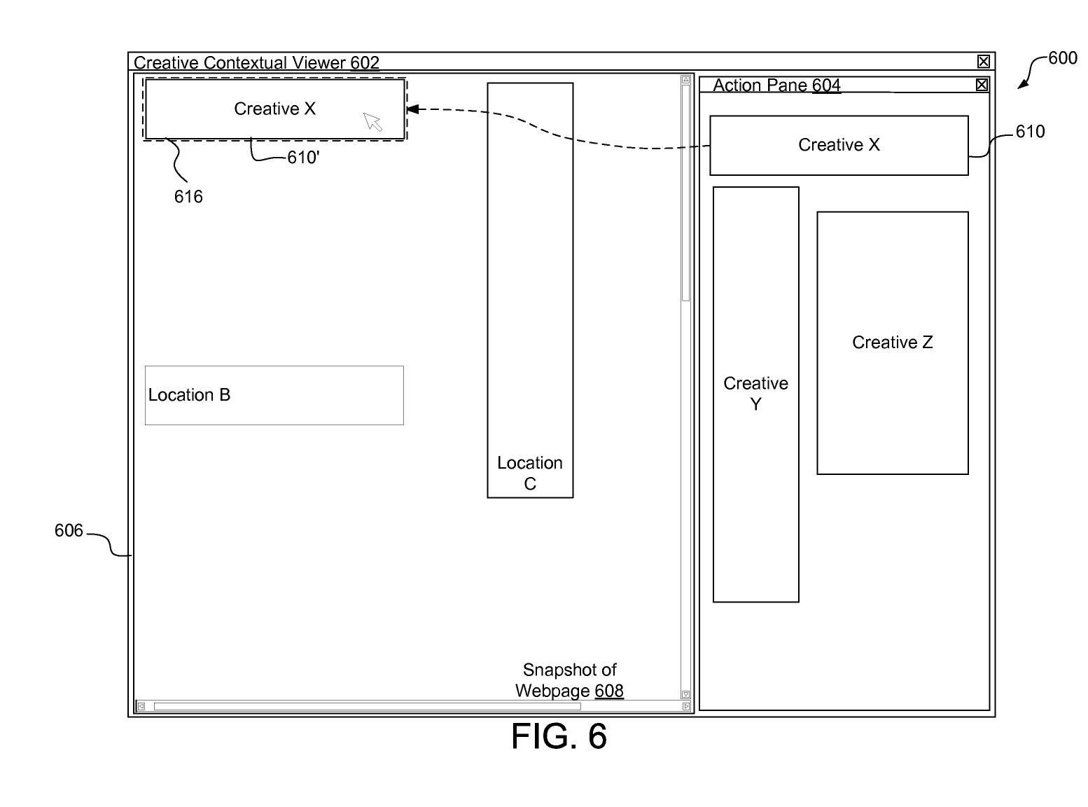

FIG. 6 depicts a user interface 600 portraying the result when a creative and a placement location have compatible attributes. Creative X 610 is shown as dragged from the action pane 504 of the creative context viewer 502 to Location A 616 on the snapshot 508 in the canvas 606 area. Location A 616 is highlighted with a border to indicate that it is the active placement location. As Creative X 610 has been determined by the CCM system to be compatible with placement Location A 616, the original creative from the web page in the snapshot at Location A 616 has been replaced by Creative X 610. The CCM system can compare any one or more of the attributes of the selected creative to determine compatibility with the chosen placement location.

Additionally, based on how the initial creatives look on a specific publisher web page in the snapshot 508, designers of creatives, with guidance from the advertiser, can view the proposed publisher advertisement space and can develop conceptual designs for each unique placement location. The messaging, colors, graphics, or other general campaign parameters may be changed to provide a better communication vehicle for that particular advertising placement location.

Known methods for building advertising campaigns are generally textual in nature and are presented in either a web-based application or in a spreadsheet format. These formats often have a long learning curve and may be error prone. Visual processes and symbols can help reduce both learning time and errors because there is visual feedback indicating to a user whether what was expected to happen actually happened.

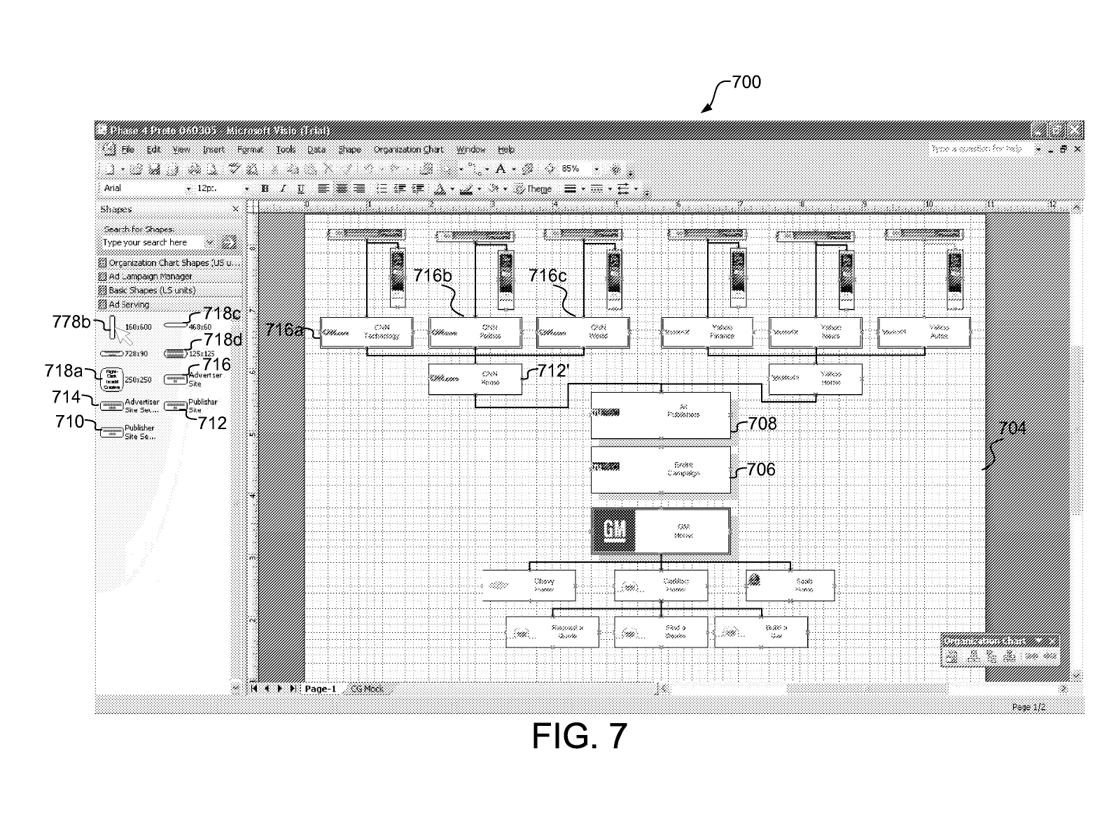

In an alternative implementation, a graphical campaign builder (GCB) 700 as depicted in FIG. 7 may be used as a front-end interface rather than a spreadsheet program as described above. In one embodiment, a GCB may consist of: 1) a graphical interface consisting of a pallet 702 of objects representing campaign elements; 2) a canvas 704 for creating the campaigns; and 3) a database for storage of the campaign data. The graphical nature of the GCB enables the user to drag and drop a creative from the palette onto a web publisher page on the canvas. At this point verification is made between the advertising creative attributes and the web publisher placement specifications. If the advertising creative attributes are within the web publisher advertising specifications the creative is visually attached to the web publisher placement. The user can multi-click on any of the creatives that are placed to access a display of their respective attributes.

The pallet 702 provides a campaign object 706 representing a new campaign that may be placed onto the canvas 704. The GCB allows a user to simply drag this and other objects from the pallet 702 and drop them onto the canvas 406. The user may similarly drag a publisher listing object 708 from pallet. By dropping the publisher listing object 708 onto the campaign object 706, the publisher listing object 708 will be linked to the particular campaign. Next a publisher site search object 710 may be dropped onto the publisher listing object 708 to select a particular publisher. A pop-up window may appear with a list of available publishers from the web publisher directors may be presented for selection. The user may then select a particular publisher and a publisher site object 712 will be placed on the canvas 704. In the example of FIG. 7, a CNN Home publisher site object 712′ is presented. Alternately, a user can drag a publisher site 712 directly from the pallet and directly assign particular publisher information to the object, e.g., through a pop-up window. This publisher information may be added to the web publisher directory.

Next, the user can select advertiser sites 716 from the pallet by either dragging an advertiser site search object 714 onto the publisher site object 712 on the canvas 704 and selecting a particular web page from a list for creative placement, or by dragging an advertising site object 716 onto the canvas 704 and directly entering the web page information as described above. The user can similarly and subsequently drag and drop creatives 718a-d onto the selected pages for those web publishers. When a particular creative size 718a-d is dropped onto an advertising site object 716, the user will be prompted to select from a list of creatives that meet the attribute criteria for the creative size.

Error checking is built into the GCB application and will highlight problems with dropping an out-of-specification creative onto a web publisher advertising placement. For example, the user places a CNN web page 716a onto the canvas 704. The CNN web page has allowable placements on a particular web page of 728×90 and 160×600. If the user tries to drag and drop a 300×250 advertisement onto the selected web page the GCB recognizes that the allowed advertising sizes and the recently dropped advertising size do not overlap and will highlight that as a discrepancy. The user will then have the option of adding a new advertisement size to that particular web publisher placement or to cancel and select another advertisement with different dimensions.

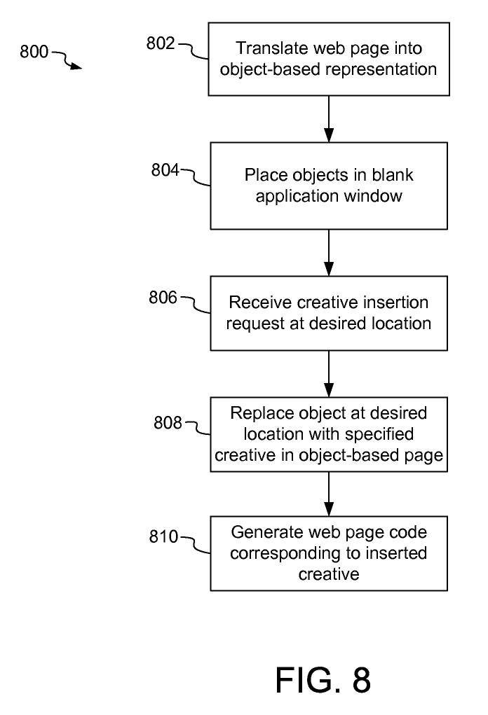

FIGS. 8, 9 and 10 are flowcharts illustrating algorithms that may be carried out by a creative management system in accordance with one embodiment. By way of example, but without limitation, the algorithms shown in FIGS. 8-10 could be implemented in a client creative management system, such as the system shown in FIG. 1. The algorithms are generally, although not necessarily, carried out on a creative (e.g., advertisement) designer's computer.

FIG. 8 is a flowchart illustrating an embodiment of a conversion algorithm 800 for converting a web page into an object-based representation that can be used for graphical insertion of creatives into a graphical application form, such as a windows application form (winForm), which is a representation of the web page. In this particular embodiment, the conversion algorithm 800 generates an object-based representation by extending the functionality of the Microsoft™ system.web API to enable it to generate objects for each table from the HTML page. It is assumed that the page has been identified.

Those skilled in the art will understand that the invention is not limited to the use of a winForm or Microsoft's™ APIs. In other operating systems other APIs may be used for the conversion. For example, other graphical application forms may be used in addition to, or as an alternative to a winForm.

In a translating operation 802, the identified web page is translated into an object-based representation and displayed within a windows application (winapp). The original identified web page is typically composed of markup language codes. In one embodiment, the translating operation 802 translates sets of code (e.g., HTML, XML, tables, etc.) into corresponding graphically presentable objects. For example, web page HTML code typically consists of tables, fonts, creatives, colors etc. Each table can be translated into an object and the advertisement graphics within those tables translated, into children of those objects. The objects and their children also include associated parameters, such as the object's location within the web page, dimensions or others.

In a placing operation 804, the objects that were generated in the translating operation 802 are placed in a window. In one embodiment, the placing operation 802 involves launching a new window, for example using winapp. The new window is initially blank. The placing operation 804 lays the objects out onto the new window at positions corresponding to their positions in the original web page. The object-based representation appears to the user to be the original web page.

In a receiving operation 806, a request is received to insert a creative at a location within the object-based representation of the web page. The request may emanate from a drag and drop input from the user. The request can also trigger an evaluation of the insertion creative against site specific rules (e.g., compatibility criteria) to determine if the insertion creative will be a compatible creative within that site environment. The request typically specifies a creative to be inserted and a location on the object-based web page where the creative should be inserted.

In a replacing operation 808, a creative (e.g., graphical advertisement object) in the object-based representation is replaced with the creative specified in the request of the receiving operation. It is assumed here that the creative specified in the request meets the compatibility criteria (discussed in further detail below) of the destination location. The creative that is replaced is at the location specified in the received insertion request. The creative specified in the request is dynamically presented in the window. As such, the window presents an object-based version of the web page with the user's selected creative at a desired location, within the context of other content of the web page.

A generating operation 810 generates a campaign in the campaign management system. In one embodiment, the generating operation 810 generates HTTP tags for the publisher to insert into their web page and uploads creatives to the hosting server(s) to await the HTTP requests.

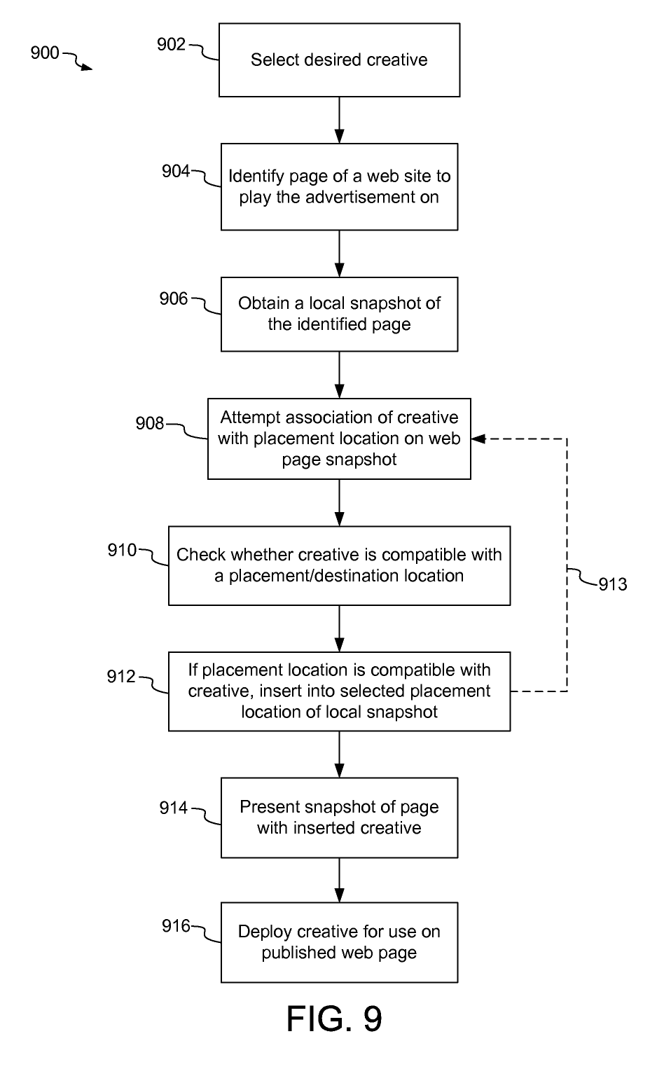

Turning to FIG. 9, the flowchart of FIG. 9 presents an identification, checking and insertion algorithm 900 for identifying a compatible creative to be inserted in a selected web page. In a selecting operation 902 a creative is selected. In one embodiment, selecting operation 902 receives input (e.g., folder, filename) from the user that identifies a selected creative. The creative may be selected from a local or remote memory that contains one or more creatives. The selecting operation 902 may also involve generating and/or editing the selected creative.

In an identifying operation 904, a web page is identified. The identifying operation 904 may involve choosing a web page and/or web site based on demographics of the web site's viewership, the topics presented on the website, or other selection criteria. For example, if the relevant creative (selected in operation 902) relates to fishing gear, a web page at the website fieldandstream.com™ maybe selected due to the relevance of the topic. When the creative relates to an advertisement, the selection of the web page and website may be part of an advertising campaign. In this respect, particular web pages or websites may be targeted according to an advertising strategy of the ad campaign.

In an obtaining operation 906, a snap shot is obtained of the web page identified in identifying operation 904. In one embodiment, the obtaining operation 906 performs an HTTP request for the identified page from a publisher website, downloads a copy of the page over the Internet, and stores the web page at a designated memory location. For example, the user's Internet browser may navigate to the selected web page and cache a copy of the web page in a cache memory. The designated memory location is typically locally accessible and the web page is stored in such a way that it can be edited during a creatives auditioning process, wherein the designer can view the selected creative in the context of the web page prior to deployment of the creative for presentation on the published web page.

In one embodiment, the obtaining operation 906 converts the web page into an object-based representation whereby the user can interact directly with a visual representation of the web page. Converting the web page into an object-based representation is discussed in further detail with respect to the object-based conversion algorithm 800 shown in FIG. 8.

In an associating operation 908, an attempt is made to associate the creative selected in operation 902 with the web page identified in identifying operation 904. In some embodiments the associating operation 908 involves a user (e.g., designer) clicking on and dragging (using a mouse input device in a graphical user interface) a creative over a desired placement location of the identified web page (or object-based representation of the web page). The placement location is typically a defined region of the web page that is available for insertion of a creative.

In other embodiments of the associating operation 908, the creative may be associated with the web page without regard to location. This is typically the case when the creative is not visually observed by the user, but observed through some other sense. For example, the creative may be an audio that is not dependent on location within the web page. In such cases, in the graphical user interface embodiments, the user may drag and drop the creative anywhere on the web page.

In a checking operation 910 it is checked whether the creative is compatible with the desired placement location. The check is made according to compatibility criteria. In one embodiment, attributes associated with the creative are compared with attributes associated with the desired placement location. Attributes may include one or more dimensions, Internet Content Rating Association (ICRA) ratings, color, contrast with surrounding web page content, or others.

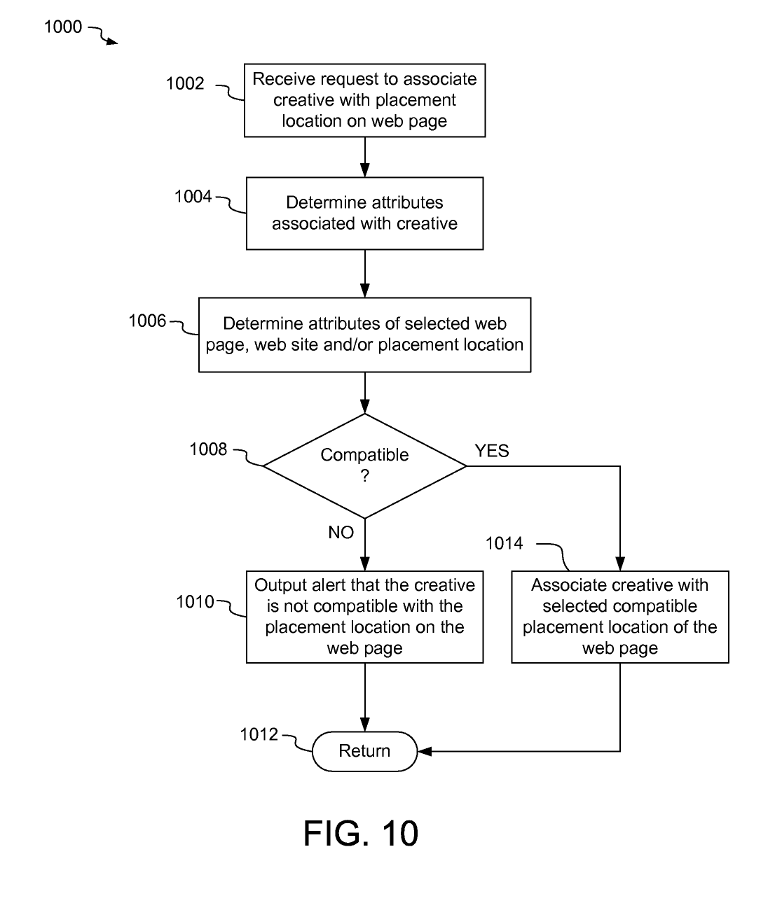

Continuing with checking operation 910, compatibility criteria may specify a required relationship between attributes in order for the creative to be compatible with the desired destination location. For example, in one embodiment a dimension attribute (e.g., height dimension) of the creative may need to be equal to the corresponding dimension attribute of the desired placement location. As another example, in some embodiments, compatibility criteria may specify that the ICRA rating of the web page be no higher than an ICRA rating of the creative. As yet another example, the compatibility criteria may specify that the color of at least a portion (e.g., the edge) of the creative not be within a specified color threshold of the web page background color in order to ensure sufficient contrast between the creative and the background of the web page. An exemplary embodiment of the checking operation 910 is illustrated in FIG. 10 and discussed in detail below.

In an inserting operation 912, if the creative is deemed to be compatible with the web page placement location, the creative is inserted into the snapshot of the web page. The inserting operation typically involves replacing content (e.g., an advertisement) of the web page with the creative in the locally accessible copy of the web page. Replacing content may involve deleting code (e.g., HTML, XML, etc.) in the snapshot of the web page and inserting code representing the creative.

Some embodiments provide an optional return path 913. In the optional return path 913, the algorithm branches back to the attempted associating operation 908. The associating operation 908 may be performed again under one or more scenarios. For example, if the creative is deemed to be incompatible, return path 913 will be taken. As another example, the designer may choose to attempt to associate the creative with the web page again. For example, the designer may not like the original placement location and want to put the creative in a different location.

In a presenting operation 914, assuming the creative is compatible, the web page is presented with the creative shown at the desired placement location. In this manner, the user (e.g., designer) can view (or otherwise observe) the creative in the context of the rest of the web page before the creative is deployed to a site that hosts the creative for presentation in the web page to other end users.

In a deploying operation 916 the creative is sent to a third party (e.g., ad hosting website, content hosting website, web page publisher) for later inclusion in the selected web page. The deploying operation 916 typically involves creating a link to the creative in the web page at the publisher site, such that the actual web page (rather than the locally accessible copy) references the creative. In this manner, any user who browses the web page will view the creative that was auditioned in the prior steps.

Turning to FIG. 10, there is shown a checking algorithm 1000 for checking whether a creative is compatible with a web page and/or a placement location on a web page. In a receiving operation 1002 a request is received to associate a creative with a placement location on the web page. The request may be issued in response to a drag and drop input from the user, wherein the use drags a creative over the web page and drops the creative at the desired placement location. The request typically includes information identifying the creative and information identifying the web page, website and/or desired placement location.

In a determining operation 1004 attributes associated with the creative are determined. In one embodiment, the determining operation 1004 determines the attributes from code (e.g., HTML, XML, etc.) associated with the creative, metadata associated with the creative, and/or actual content of the creative (e.g., color encoding information of the creative). In some embodiments, the creative is an “intelligent” object that encapsulates attributes of the creative and in some cases functions for interacting with the object. In these embodiments, the object representing the creative is queried for attributes.

Attributes of the creative may include, without limitation, one or more dimensions, shape, color, whether animation is included, whether audio is included, ICRA rating and/or a commercial entity associated with the creative.

In another determining operation 1006 attributes of the selected web page, website and/or desired placement location are determined. In one embodiment, the determining operation 1006 determines the attributes from code (e.g., HTML, XML, etc.) associated with the web page, metadata associated with the web page, and/or actual content of the web page. Attributes of the web page, website and/or desired placement location may include, without limitation, one or more dimensions, shape, color, whether animation is allowed, whether audio is allowed, ICRA rating, or a commercial entity associated with the web page (e.g., other advertisers on the web page).

In a query operation 1008 it is determined whether the attributes of the creative are compatible with the attributes of the web page, website and/or desired placement location. In one embodiment of the query operation 1008, compatibility criteria are applied to the determined attributes. Compatibility criteria may specify relative similarity or differences between creative attributes and web page, website and/or placement location attributes. In some embodiments, and depending on the type of attributes, a comparison is made between the attributes. For example, one or more dimensions (e.g., height, width, or both) of the creative may be compared to the corresponding dimension of the desired placement location to determine if the creative will fit in the desired placement location. As other examples, ICRA ratings may be compared, shapes may be compared and/or colors may be compared.

If the compatibility criteria are not met, the algorithm 1000 branches “NO” to an alerting operation 1010. The alerting operation 1010 notifies the user that there is at least one incompatibility between the creative and the web page, website and/or desired placement location. The incompatibility may be presented graphically to the user in some way. For example, a red “X” may be shown over the desired placement location and/or the creative. The alerting operation 1010 may prompt or enable the user to attempt to associate the creative with the web page again (e.g., attempt to place at a different placement location).

If, on the other hand, the query operation 1008 determines that the creative is compatible with the web page, website and/or desired placement location, the algorithm 1000 branches “YES” to an associating operation 1014. In one embodiment, the associating operation 1014 creates a link between the web page and the creative. This may involve adding a reference to the creative in the web page. Alternatively, the associating operation 1014 may maintain a table with entries that associate the web page (or placement locations thereon) with creatives to be placed on the web page.

After the alerting operation 1010 and the associating operation 1014, the algorithm 1000 returns via returning operation 1012. Returning operation 1012 may return an indicator (e.g. flag, Boolean, etc.) that indicates whether the creative was compatible with the selected web page, website and/or desired placement location.

In some embodiments, the algorithms of FIGS. 8-10 may be applied to multiple creatives substantially simultaneously (within a short period of time). For example, in some embodiments, the user may identify multiple creatives, and the algorithms can be carried out sequentially or in parallel with respect to each creative to determine compatibility and insert the creatives that are compatible. In some embodiments, when multiple creatives are identified and checked, creatives that are incompatible are filtered out. For example, the filtered creatives may be presented at a different location in a GUI than nonfiltered creatives or presented in grayscale or with transparency to indicate they've been filtered and cannot be inserted into the selected web page.

### Exemplary Computing System

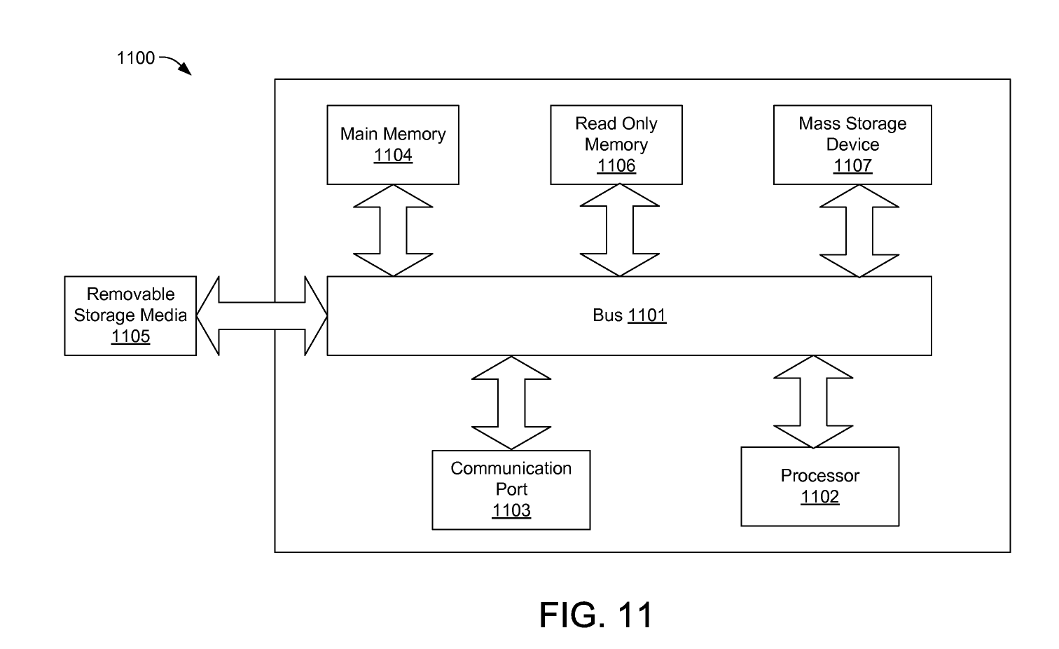

FIG. 11 is a schematic diagram of a computing device 1100 upon which a creatives management or deployment system may be implemented. As discussed herein, embodiments of the present invention include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

According to the present example, the computing device 1100 includes a bus 1101, at least one processor 1102, at least one communication port 1103, a main memory 1104, a removable storage media 1105 a read only memory 1106, and a mass storage 1 107. Processor(s) 1102 can be any know processor, such as, but not limited to, an lntel® Itanium® or Itanium 2® processor(s), or AMD® Opteron® or Athlon MP® processor(s), or Motorola® lines of processors. Communication port(s) 1103 can be any of an RS-232 port for use with a modem based dialup connection, a 10/100 Ethernet port, or a Gigabit port using copper or fiber. Communication port(s) 1103 may be chosen depending on a network such a Local Area Network (LAN), Wide Area Network (WAN), or any network to which the computing device 1100 connects. The computing device 1100 may be in communication with peripheral devices (not shown) such as, but not limited to, printers, speakers, cameras, microphones, or scanners.

Main memory 1104 can be Random Access Memory (RAM), or any other dynamic storage device(s) commonly known in the art. Read only memory 1106 can be any static storage device(s) such as Programmable Read Only Memory (PROM) chips for storing static information such as instructions for processor 1 102. Mass storage 1107 can be used to store information and instructions. For example, hard disks such as the Adaptec® family of SCSI drives, an optical disc, an array of disks such as RAID, such as the Adaptec family of RAID drives, or any other mass storage devices may be used.

Bus 1101 communicatively couples processor(s) 1102 with the other memory, storage and communication blocks. Bus 1101 can be a PCI/PCI-X or SCSI based system bus depending on the storage devices used. Removable storage media 1105 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

What is claimed is:

1. A method comprising:
identifying a creative;
identifying a destination location for the creative;
comparing the creative with the destination location to determine whether the creative is compatible with the destination location; and
associating the creative with the destination location when the creative is compatible with the destination location.

2. A method according to claim 1, wherein comparing the creative with the desired destination location includes comparing the area of the creative with the area of the desired destination location.

3. A method according to claim 1, wherein comparing the creative with the desired destination location includes dragging and dropping the creative to the desired destination location within a graphical user interface.

4. A method according to claim 1, wherein the creative and the destination location have one or more attributes, and comparing the creative with the destination location includes comparing the attributes of the creative with the attributes of the destination location.

5. A method according to claim 1, further comprising:
obtaining a snapshot of a web page including the destination location;
inserting the creative in the destination location in the snapshot of the web page; and
displaying the web page with the creative when the creative and the destination location are compatible.

6. A method comprising:
identifying a destination location;
setting at least one attribute of the destination location;
importing a plurality of creatives;
comparing at least one attribute of one or more plurality of creatives to the at least one attribute of the destination location;
sorting the plurality of creatives based on the attribute comparison.

7. A method according to claim 6, wherein the sorting operation includes ranking the creatives based on the attribute comparison.

8. A method according to claim 6, wherein at least one of the attributes of the destination location relates to the area of the destination location and at least one attribute of each creative relates to the area of the creative.

9. A method according to claim 6, wherein the comparing operation determines whether each of the plurality of creatives is compatible with the destination location.

10. A method according to claim 9, further comprising filtering the creatives that are not compatible with the destination location.

11. A method according to claim 6, further comprising hierarchically displaying the sorted creatives in a graphical user interface.

12. A method according to claim 6, wherein the comparing includes selecting one or more creatives from the plurality of imported creatives, and dragging and dropping the selected creatives to the desired destination location within a graphical user interface.

13. A method for auditioning a creative, comprising:
selecting a creative;
selecting a destination location in a web page;
acquiring a local snapshot of the web page; and
displaying the selected creative at the destination location using the local snapshot of the web page.

14. A method according to claim 13, wherein the creative is stored locally.

15. A method according to claim 13, wherein the creative is stored at a remote location.

16. A method according to claim 13, further comprising:
comparing the creative with the destination location to determine compatibility; and
displaying the selected creative at the destination location when the creative is compatible with the destination location.

17. A method according to claim 16, further comprising:
displaying an error message when the creative is not compatible with the destination location.

18. A method according to claim 16, further comprising:
associating the creative with the destination location if the creative is compatible with the destination location.

19. A method according to claim 13 wherein the operations are performed to create an online advertising campaign, the method further comprising managing creatives representing advertisements of the online advertising campaign, in part, through a spreadsheet application.

20. A method according to claim 19 wherein the managing operation comprises associating one or more creatives with the web page.

21. A method according to claim 19 wherein the managing operation further comprises identifying a plurality of web pages to be targeted by the advertising campaign.

22. A method according to claim 21, further comprising deploying the creatives to a content server for display on the plurality of web pages.

23. A method according to claim 22, further comprising reporting advertising statistics through the spreadsheet, the advertising statistics being representative of effectiveness of the creatives in advertising.
